(19) United States
(12) Patent Application Publication
(10) Pub. No.: US 2024/0354721 A1
(43) Pub. Date: Oct. 24, 2024

(54) INFORMATION PRESENTATION CONTROLLER, METHOD AND PROGRAM

(71) Applicant: NIPPON TELEGRAPH AND TELEPHONE CORPORATION, Tokyo (JP)

(72) Inventors: Ryo HASHIMOTO, Musashino-shi, Tokyo (JP); Fumiya AKASAKA, Musashino-shi, Tokyo (JP); Yoshiki NISHIKAWA, Musashino-shi, Tokyo (JP); Tomoyuki KANEKIYO, Musashino-shi, Tokyo (JP)

(73) Assignee: NIPPON TELEGRAPH AND TELEPHONE CORPORATION, Tokyo (JP)

(21) Appl. No.: 18/569,223

(22) PCT Filed: Jun. 14, 2021
(86) PCT No.: PCT/JP2021/022563

§ 371 Date: Dec. 12, 2023

(51) Int. Cl. G06Q 20/06

(52) U.S. Cl. CPC G06Q 20/065

(57) ABSTRACT

One aspect of the present invention is an information presentation control device used in a system for managing circulation of an electronic token used as a regional currency, and the device acquires use history information indicating a use history of the electronic token with respect to an event executed in each region, acquires first circulation information indicating a circulation activity level of the electronic token in an entire target region on the basis of the use history information, acquires second information indicating circulation activity level of the electronic token for each area in which the event is executed, and outputs the acquired first and second circulation information.

### TECHNICAL FIELD

One aspect of the present invention relates to an information presentation control device, method and program used in a system for managing currency of electronic tokens used, for example, as regional currency.

### BACKGROUND ART

As one of measures for promoting regional revitalization business, various approaches for activating regional economy by using regional currency has been reported (see, for example, NPL 1). To make this kind of approach successful, promotion of use of regional currency is a key. On the other hand, as a similar example, there has been proposed, for example, a mechanism for giving a reward to participants by utilizing regional currency in order to activate social contribution activity and regional community activity.

### CITATION LIST

### Non Patent Literature

[NPL 1] “Report of the Study Group for Regional Revitalization by Introducing Regional Currency in FY 2018,” Osaka Municipal Promotion Association, Osaka Municipal Employees Training and Research Center, March 2019, available at Internet <URL: http://www.masse.or.jp/ikkrwebBrowse/material/files/group/17/tiikitsu ka-houkokusyo.pdf>

### SUMMARY OF INVENTION

### Technical Problem

However, in general, the conventionally proposed approach is to post simply a content for notifying the guidance and execution state of an event, when various events are held, on a Web page the user terminal or to deliver simultaneously the content to the user terminal. Thus, the event is hardly activated and the utilization of the regional currency is not promoted.

The present invention has been made by paying attention to the above circumstances, and it is intended to provide a technique which enables a user to accurately grasp the state of activation of an event and thereby enables the user to promote the use of an electronic token used as a regional currency.

### Solution to Problem

For solving above problem, a first aspect of the present invention is an information presentation control device or method used in a system for managing currency of an electronic token used as a regional currency which:
acquires use history information indicating a use history of the electronic token with respect to an event executed in each region;
acquires first circulation information indicating a circulation activity level of the electronic token in the entire target region based on the use history information; acquires second information indicating circulation activity of the electronic token for each area in which the event is executed;
and outputs the acquired first circulation information and the acquired second circulation information.

According to the first aspect of this invention, the information representing the circulation activity of the system's latest electronic tokens and the circulation activity of the electronic tokens in the region where the event is taking place is output. Therefore, for example, a system manager or a user can grasp the circulation state of the entire system of the electronic token and circulation information by the region from the output information, and thereby, it is possible to take measures for promoting the circulation of the electronic token.

A second aspect of this invention further provides a content information generation processing unit or generation process to generate content information reflecting the circulation activity of the electronic tokens in the entire target region and the circulation activity of the electronic tokens by region based on the first circulation information and the second circulation information.

According to the second aspect of the present invention, content information in which the circulation activity of the latest electronic token and the circulation activity of the electronic token for each region are reflected is generated and presented to a user. Thus, the user can easily and accurately confirm the quantitative and regional circulation state of the electronic token by the content information, and as a result, the user can easily participate in the event, and the event is activated, and the circulation of the token can be promoted.

### Advantageous Effects of Invention

That is, according to each aspect of the present invention, it is possible for a user to accurately grasp the state of activation of an event, and to provide a technique for promoting use of an electronic token used as a regional currency.

### BRIEF DESCRIPTION OF DRAWINGS

FIG. 1 is a diagram showing an example of a configuration of a regional currency circulation system equipped with a server device that functions as an information presentation control device according to an embodiment of the present invention.

FIG. 2 is a block diagram showing an example of a hardware configuration of the server device shown in FIG. 1.

FIG. 3 is a block diagram showing an example of a software configuration of the server device shown in FIG. 1.

FIG. 4 is a flowchart showing the processing steps and contents of transfer execution processing and transfer history management processing performed by the server device shown in FIG. 3.

FIG. 5 is a flowchart showing processing steps and processing contents of content generation processing according to token usage status, which is executed by the server device shown in FIG. 3.

FIG. 6 is a flowchart showing steps and contents of deriving processing of the most recent circulation token activity level in the steps shown in FIG. 5.

FIG. 7 is a diagram showing an example of information stored in a token transfer event information DB of the server device shown in FIG. 3.

FIG. 8 is a diagram showing an example of information stored in a user possession token quantity list DB of the server device shown in FIG. 3.

FIG. 9 is a diagram showing an example of information stored in a token transfer history DB of the server device shown in FIG. 3.

FIG. 10 is a diagram showing an example of information stored in a content unit DB of the server device shown in FIG. 3.

FIG. 11 is a diagram showing an example of a first content stored in the content unit DB shown in FIG. 10.

FIG. 12 is a diagram showing an example of the first and a second content stored in the content unit DB shown in FIG. 10.

FIG. 13 is a diagram showing an example of information stored in a specific region information DB of the server device shown in FIG. 3.

FIG. 14 is a diagram showing an example of a relationship between a regional area and an event occurrence position on a regional map.

FIG. 15 is a diagram showing a first example of a content generated by a content per token circulation quantity generation processing unit of the server device shown in FIG. 3.

FIG. 16 is a diagram showing a second example of the content generated by the content per token circulation quantity generation processing unit of the server device shown in FIG. 3.

FIG. 17 is a diagram showing a third example of the content generated by the content per token circulation quantity generation processing unit of the server device shown in FIG. 3.

FIG. 18 is a diagram showing a fourth example of the content generated by the content per token circulation quantity generation processing unit of the server device shown in FIG. 3.

FIG. 19 is a diagram showing a fifth example of the content generated by the content per token circulation quantity generation processing unit of the server device shown in FIG. 3.

FIG. 20 is a diagram showing a sixth example of the content generated by the content per token circulation quantity generation processing unit of the server device shown in FIG. 3.

FIG. 21 is a diagram showing a seventh example of the content generated by the content per token circulation quantity generation processing unit of the server device shown in FIG. 3.

### DESCRIPTION OF EMBODIMENTS

Hereinafter, an embodiment according to the present invention will be described with reference to the drawings.

### One Embodiment

### Configuration Example

### (1) System

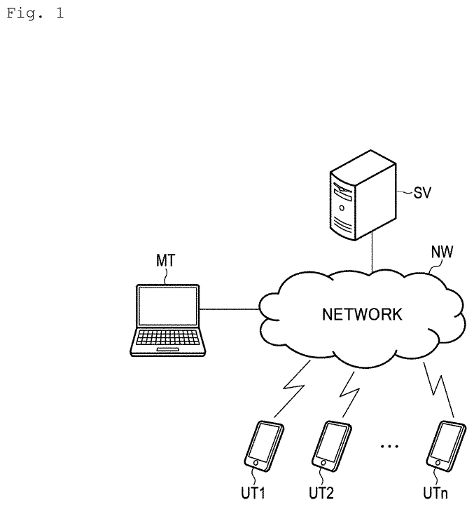

FIG. 1 is a diagram showing an example of a configuration of a regional currency circulation system including an information presentation control device according to one embodiment of the present invention. In one embodiment, a case that an electronic token (hereinafter referred to simply as a token) is used as a regional currency will be described as an example.

The regional currency circulation system according to one embodiment of the present invention includes a server device SV as an information presentation control device according to one embodiment of the present invention. To the server device SV, user terminals UT1 to UTn used by a plurality of users U1 to Un, which are users of electronic tokens as regional currency, and a manager terminal MT used by a system manager can be connected via a network NW.

The user terminals UT1 to UTn are portable terminals such as smartphones or tablet terminals. As the user terminals UT1 to UTn, wearable terminal, portable personal computer, fixed installation type personal computer or the like may be used.

The user terminals UT1 to UTN are provided with a browser used for browsing information of the server device SV, a mailer or an SNS (Social Network System) application for receiving content information, etc. distributed from the server device SV, and an application for performing various procedures such as acquiring and using electronic tokens, as the main functions related to this invention.

The network NW includes, for example, a wide area network with the Internet as a core and an access network for accessing the wide area network. As the access network, for example, a public communication network using wired or wireless, a LAN (Local Area Network) using wired or wireless, and a CATV (Cable Television) network are used.

### (2) Server Device SV

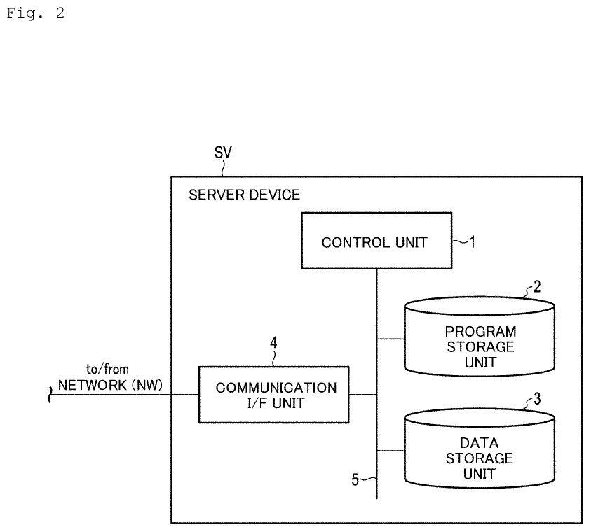

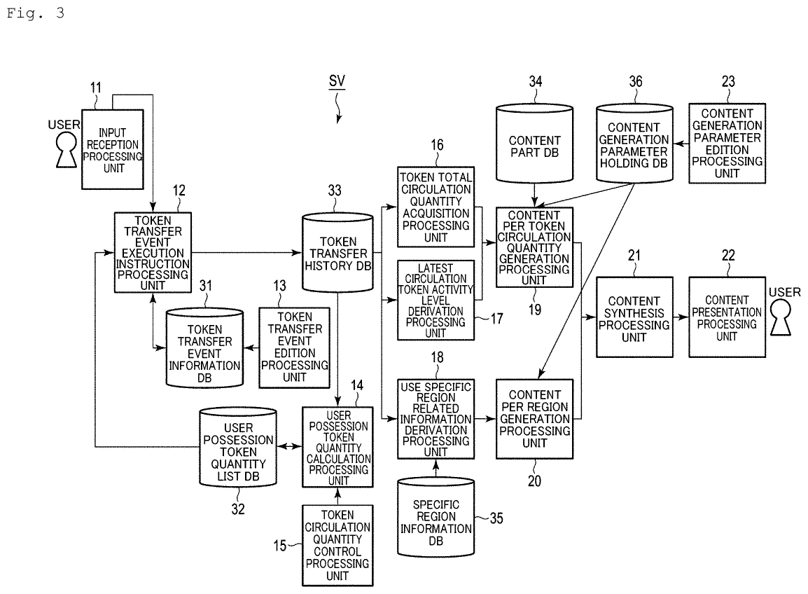

FIG. 2 and FIG. 3 are block diagrams showing hardware and software functional configurations of a server device SV.

The server device SV consists of a server computer located on the Web or in the cloud, for example, and is equipped with a control unit 1 using a hardware processor such as a central processing unit (CPU). To the control unit 1, a program storage unit 2 and a data storage unit 3 and a communication I/F unit 4 are connected through a bus 5.

The communication I/F unit 4 transmits and receives information data between the user terminals UT1 to UTn and the manager terminal MT by using a communication protocol defined by a network NW under the control of the control unit 1.

The program storage unit 2 is composed of a combination of nonvolatile memory that can be written to and read from at any time, such as an HDD (Hard Disk Drive) or an SSD (Solid State Drive), as a storage medium, and nonvolatile memory such as a ROM (Read Only Memory), for example, and stores in addition to middleware such as an OS (Operating System), application programs necessary to execute various control processes related to one embodiment of this invention.

The data storage unit 3 is, for example, a combination of a nonvolatile memory such as an HDD or an SSD that can be written to and read from at any time, and a volatile memory such as a RAM (Random Access Memory) as a storage medium, as a main storage unit according to one embodiment of the present invention, and equipped with a token transfer event information database (a database will hereinafter be referred to as a database as a DB) 31, a user possession token quantity list DB 32, a token transfer history DB 33, a content part DB 34, a specific region information DB 35 and a content generation parameter holding DB 36.

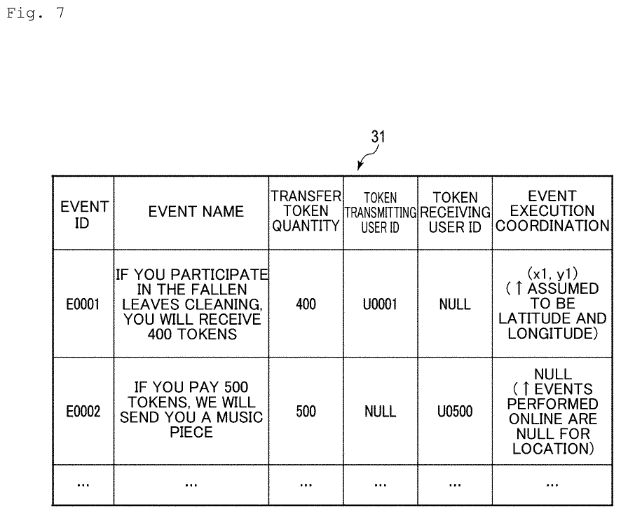

The token transfer event information DB 31 is used for managing information representing an event that can use an electronic token. FIG. 7 shows an example of information stored in the token transfer event information DB 31, and this example shows a case in which an event name, a quantity of tokens transferred in the execution of the event, a user ID of the user who is the sender of the token, a user ID of a user who is a receiver of the token, and coordinate information of the event execution location are stored in association with the event ID.

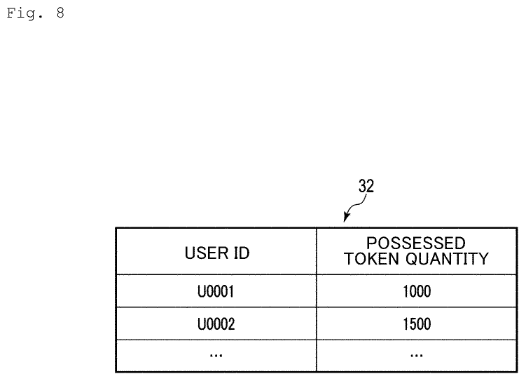

The user possession token quantity list DB 32 is used for managing token quantity possessed by the users U1 to Un. FIG. 8 shows an example of information stored in the user possession token quantity list DB 32, and in this example, the token quantity possessed by a user is stored in association with the user ID of each user.

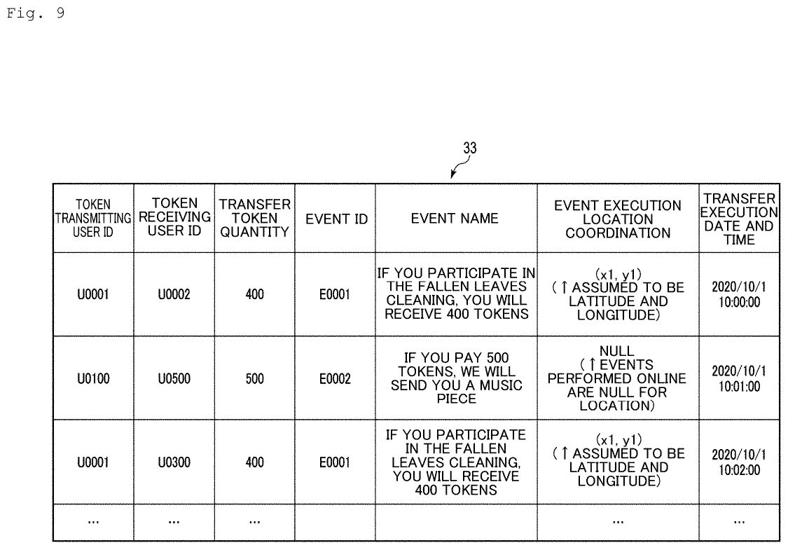

The token transfer history DB 33 is used for managing a transfer history of a token generated in association with participation of a user in an event. FIG. 9 shows an example of information stored in the token transfer history DB 33, and this example shows a case in which every time a token is used, a transmission user ID or a reception user ID of the token, a transferred token quantity, a target event ID and event name, an event execution location coordinate information, and a transfer execution date and time of the token are stored.

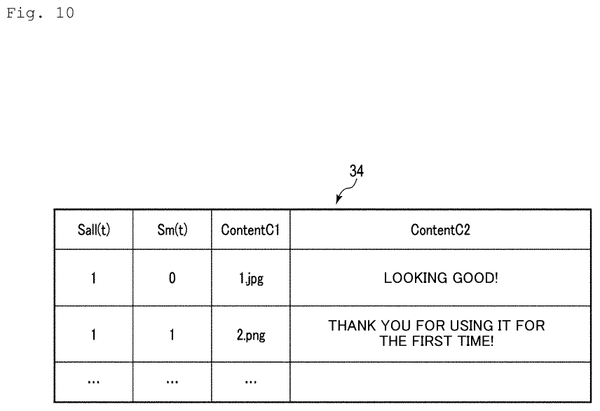

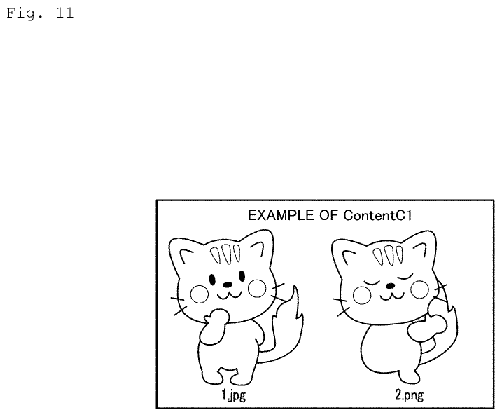

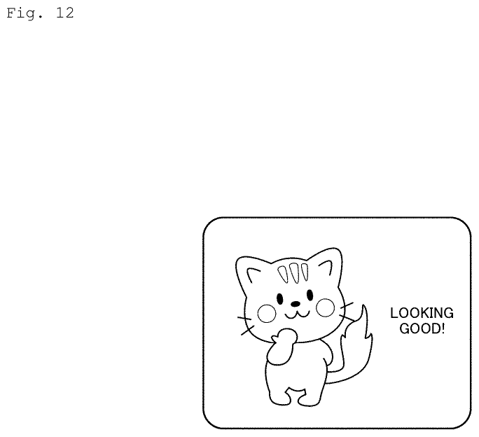

The content part DB 34 stores a plurality of content parts corresponding to determination result of the circulation quantity of the token. FIG. 10 shows an example of information stored in the content part DB 34, and this example shows a case in which first and second contents C1 and C2 of different kinds (types) are stored, in accordance with a combination of a content outline determination value Sall(t) at time t calculated on the basis of the total circulation quantity of tokens, and a content detail determination value Sm(t) at time t calculated on the basis of an elapsed time from the start of use of the system and the latest token circulation quantity. For example, illustration data as shown in FIG. 11 is used as the first content C1, and for example, text data is used as the second content C2. FIG. 12 shows an example of a content obtained by synthesizing the first content C1 and the second content C2, and is generated by a content per token circulation quantity generation processing unit 19 described later.

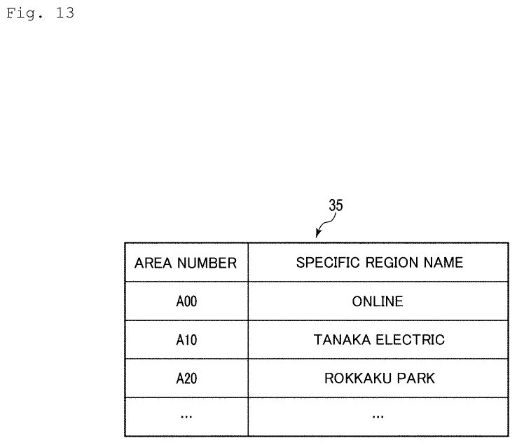

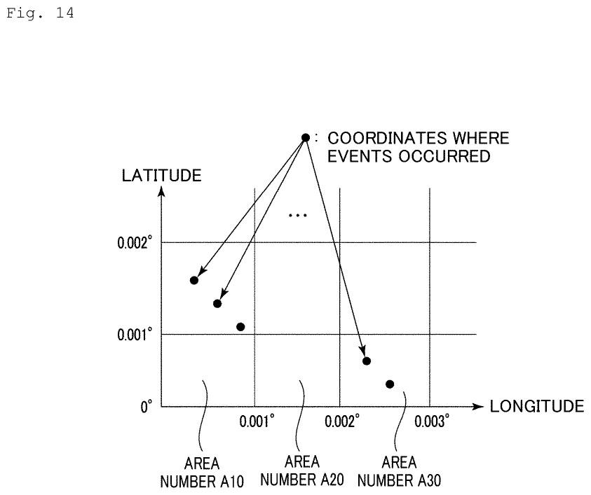

The specific region information DB 35 manages a specific region in which an event is executed. FIG. 13 shows an example of information stored in the specific region information DB 35, and in this example, a case in which the area name is stored in association with the area number of the region where the event is executed is shown. FIG. 14 shows an example of a relationship between a plurality of divided areas and an event execution position when a region map represented by latitude and longitude is divided into meshes.

The content generation parameter holding DB 36 manages a parameter for determining the activity level of circulation of tokens in the latest period and the activity of circulation of tokens in a specific region where an event is executed.

As processing functions according to one embodiment of the present invention, a control unit 1 includes an input reception processing unit 11, a token transfer event execution instruction processing unit 12, a token transfer event edition processing unit 13, a user possession token quantity calculation processing unit 14, a token circulation quantity control processing unit 15, a token total circulation quantity acquisition processing unit 16, a latest circulation token activity level derivation processing unit 17, a use specific region related information derivation processing unit 18, a content per token circulation quantity generation processing unit 19, a content per region generation processing unit 20, a content synthesis processing unit 21, a content presentation processing unit 22, and a content generation parameter edition processing unit 23. These processing function units 11 to 23 are each realized by causing the hardware processor of the control unit 1 to execute a program stored in the program storage unit 2.

The input reception processing unit 11 performs processing for receiving an event participation request transmitted from the user terminals UT1 to UTn via a communication I/F unit 4.

The token transfer event execution instruction processing unit 12 reads corresponding token transfer event information and user possession token list information from the token transfer event information DB 31 and the user possession token quantity list DB 32 on reception of above event participation request. And then, the token transfer event execution instruction processing unit 12, based on the token transfer event information and the user possessed token list information above read, determines whether or not the user of the participation request source satisfies a participation condition to the event, and when participation is possible, an execution instruction of a token transfer from the execution user of the event to the participation user or a token transfer from the participation user to the execution user is outputted. The token transfer event execution instruction processing unit 12 performs processing for storing information indicating the token transfer history in the token transfer history DB 33.

The token transfer event edition processing unit 13 performs editing processing of information stored in the token transfer event information DB 31, for example, in accordance with operation of a system manager or a user.

The user possession token quantity calculation processing unit 14 reads token transfer history information for each user from the token transfer history DB 33, calculates the user possession token quantity again on the basis of the read token transfer history information, and performs processing for updating the user possession token quantity in the above user possession token quantity list DB 32.

The token circulation quantity control processing unit 15 distributes tokens to a user for the purpose other than a token event or collects tokens from the user in response to a request of a token issuer, for example.

The token total circulation quantity acquisition processing unit 16 performs processing for calculating a total circulation quantity Tall(t) of the token at a time t on the basis of the information stored in the token transfer history DB 33.

The latest circulation token activity level derivation processing unit 17 calculates an activity level M(t) of token circulation at a time t from a token circulation quantity in a past predetermined period L and a token circulation quantity in a latest period 1 shorter than the period L on the basis of information stored in the token transfer history DB 33. The latest circulation token activity level derivation processing unit 17 also performs processing for deriving a flag value F(t) used for determining whether or not the calculation formula of the above activity level M(t) can be applied. An example of the process of deriving the latest circulation token activity level will be described in Exemplary Operation.

The use specific region related information derivation processing unit 18 derives information on a token event in the latest period 1 for each of a plurality of areas defined by dividing a service target region into a mesh shape on the basis of the information stored in the token transfer history DB 33. An example of the process for deriving the information related to the specific region for use will be described in Exemplary Operation.

The content per token circulation quantity generation processing unit 19 generates a total circulation quantity Tall(t) of the token at the time t obtained by the token total circulation quantity acquisition processing unit 16, on the basis of the parameter stored in the content generation parameter holding DB 36 and the content parts stored in the content part DB 34, and generates contents per token circulation quantity that changes according to the circulation activity level M(t) of the latest token at the time t obtained by the latest circulation token activity level derivation processing unit 17.

The content per region generation processing unit 20 specifies a name of an area in which the use of tokens is increased on the basis of the parameter stored in the content generation parameter holding DB 36 and the token circulation quantity for each area obtained by the use specific region related information derivation processing unit 18, and performs content per region generation processing including the specified area name and an event name executed in the area.

The content synthesis processing unit 21 synthesizes the content per token circulation quantity generated by the above content per token circulation quantity generation processing unit 19 and content per region generated by the above content per region generation processing unit 20, and performs processing for generating content information to be presented to a user.

The content presentation processing unit 22 performs processing for distributing the content information generated by the content synthesis processing unit 21 from the communication I/F unit 4 to the user terminals UT1 to UTn.

### Exemplary Operation

Next, an exemplary operation of the server device configured in the above-described manner will be described.

### (1) Management of Token Transfer and Transfer History

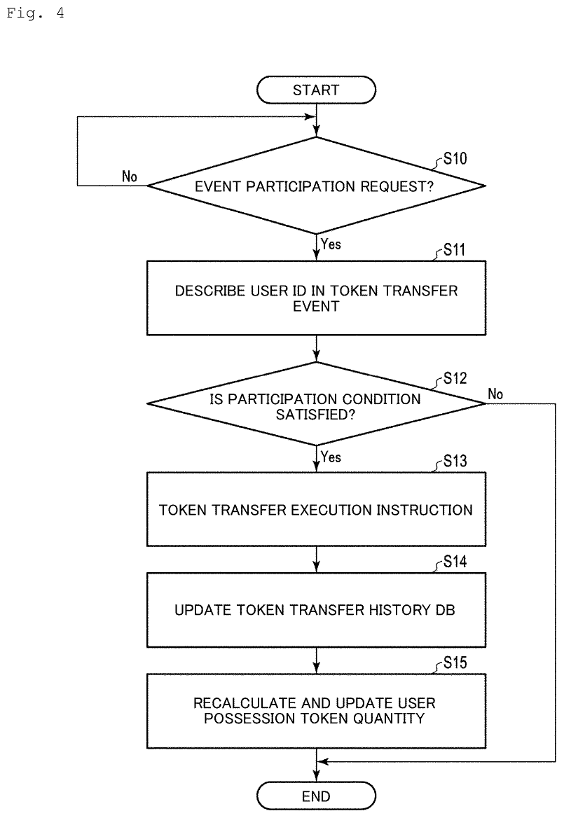

FIG. 4 is a flow chart showing the processing procedure and the processing contents of the token transfer execution processing and the transfer history management processing executed by the control unit 1 of the server device SV.

Now, it is assumed that token transfer event information as shown in FIG. 7 is stored in the token transfer event information DB 31 under the control of the token transfer event edition processing unit 13. In this example, the user ID (U0001) of the executor of the event is described in a column of the token transmission user ID in association with the event ID (E0001) of the event of “fallen leaves cleaning”, and the user ID (U0500) of the executor of the event is described in a column of the token reception user ID in association with the event ID (E0002) of the event of “presentation of music piece”.

In this state, it is assumed that, for example, a user U2 who desires to participate in an event transmits a participation request including an event ID desired to participate and its own user ID from its own user terminal UT2 to a server device SV. On the other hand, when a control unit 1 of the server device SV receives the participation request in a step S10, the token transfer event execution instruction processing unit 12 first describes, in a step S11, the user ID of the request source in a description column of the user ID in the token transfer event information DB 31, in association with the event ID of the participation object.

For example, when the user desires to participate in an event of “fallen leaves cleaning”, the token transfer event execution instruction processing unit 12 describes a request source user ID (U0002, for example) in a description column of the token reception user ID in association with the event ID (E0001). Also, for example, when the user desires to participate in an event of “presentation of music piece”, the token transfer event execution instruction processing unit 12 describes a request source user ID (U0002, for example) in a description column of a token transmission user ID in association with the event ID (E0002).

Next, in a step S12, the token transfer event execution instruction processing unit 12 determines whether or not the request source user U2 satisfies a condition of participation in the event. The determination processing is performed by comparing the possessed token quantity of the user U2 managed by the user possession token quantity list DB 32 with the transfer token quantity required for participating in an event that the user desires to participate. As a result of the determination, for example, when the quantity of tokens possessed by the user is equal to or larger than the quantity of transfer tokens necessary for participation of the event, the participation of the user to the event is permitted, and when the quantity of tokens is less than the quantity of tokens, the participation is rejected. At this time, the determination result may be notified to the user terminal UT2 of the request source user.

As a result of the determination, when the user U2 satisfies a condition of participation in the event, a token transfer event execution instruction processing unit 12 instructs execution of token transfer processing in a step S13. As a result, for example, the following token transfer process is performed. That is, when the user U2 participates in the event of “fallen leaves cleaning”, the token (400) to be a counter value is transferred from the execution user U1 to the participation user U2, and when the user U2 participates in the event of “presentation of music piece”, the token (500) to be a counter value is transferred from the participation user U2 to the execution user U1.

When the transfer processing of the token is finished, the token transfer event execution instruction processing unit 12 adds information indicating the transfer history of the token to the token transfer history DB 33 in a step S14. At this time, as shown in FIG. 9, the information representing the transfer history of the token includes an event ID, an event name, event execution position coordinates and transfer execution date and time are also included.

When the update processing of the token transfer history information is finished, the control unit 1 of a server device SV reads the token transfer history information for each user from the token transfer history DB 33 in a step S15 under the control of the user possession token quantity calculation processing unit 14. Then, based on the read token transfer history information, the possessed token quantity of the user is calculated again, and the possessed token quantity of the user possession token quantity list DB 32 is updated.

### (2) The Calculation of the Token Use State and the Generation of the Content Based on the Result

The server device SV executes processing related to calculation of a token use state and generation of content based on the result, for example, periodically or at arbitrary timing, while performing processing related to management of the transfer of the token and the transfer history.

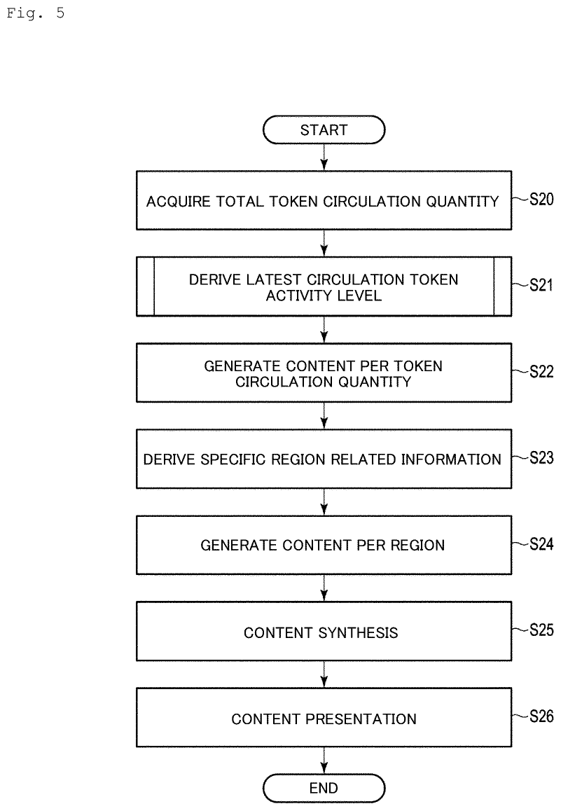

FIG. 5 is a flowchart showing the processing procedure and the processing contents of the calculation processing of the token use state and the generation processing of the contents based on the result, which are executed by the control unit 1 of the server device SV.

### (2-1) Calculation of Total Token Circulation Quantity

The control unit 1 of a server device SV reads token transfer history information from the token transfer history DB 33 in a step S20, and under the control of a token total circulation quantity acquisition processing unit 16, calculates the total circulation quantity Tall(t) of the tokens at the time t, on the basis of the read token transfer history information.

### (2-2) Calculation of the Circulation Activity Level of Tokens in the Latest Period

The control unit 1 of a server device SV reads token transfer history information from the token transfer history DB 33 in a step S21 under the control of the latest circulation token activity level derivation processing unit 17. Then, based on the read token transfer history information, the above circulation activity level M(t) of the token at an arbitrary time t of the latest period 1 is calculated from the token circulation quantity (token long term circulation quantity) in the past predetermined period L and the token circulation quantity (token short term circulation quantity) in the latest period 1 shorter than the period L. The latest circulation token activity level derivation processing unit 17 derives a flag value F(t) used for determining whether or not the calculation formula of the circulation activity level M(t) can be applied.

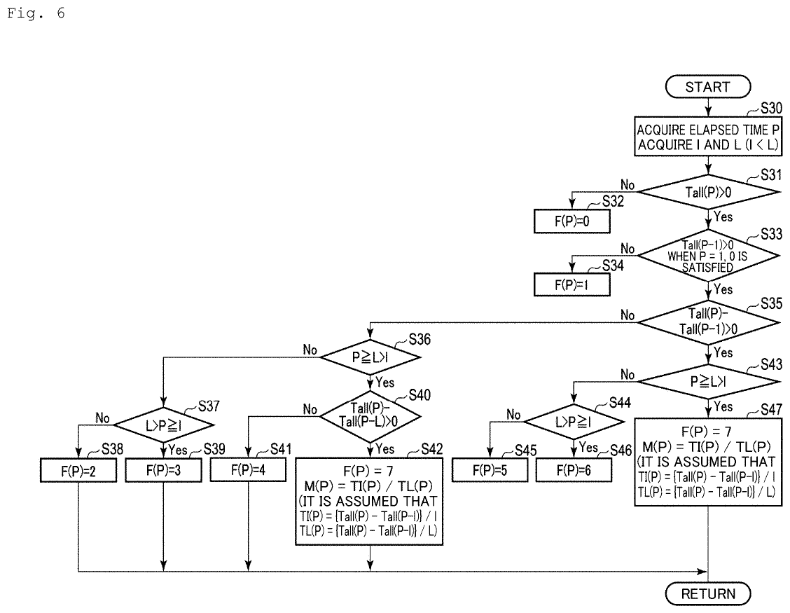

FIG. 6 is a flowchart showing an example of the processing procedure and the processing contents of the calculation processing of the circulation activity level M(t) and the derivation processing of the determination flag F(T) executed by the latest circulation token activity level derivation processing unit 17.

First in a step S30, the latest circulation token activity level derivation processing unit 17 acquires, for example, an elapsed time P from the start of the operation of the system and calculates a total circulation quantity Tall(P) of tokens in this period P. Also, parameters l and L related to time are read from the content generation parameter holding DB 36. L indicates a predetermined period in the past, and l indicates a latest period shorter than the predetermined period L, and these values can be set arbitrarily.

Next in a step S31, the latest circulation token activity level derivation processing unit 17 determines whether or not the total circulation quantity Tall(P) of tokens in the period P is larger than “0” on the basis of the calculated total circulation quantity of tokens in the period P. When Tall(P)=0 as a result of the determination, it is determined that the token after system operation is not yet used and set to a flag value F(P)=0 in a step S32, the process is terminated.

On the other hand, when Tall(P)>0, the latest circulation token activity level derivation processing unit 17 determines that the token is used, and then determines whether the total circulation quantity Tall(P−1) of the token in a period P−1 past the period P is larger than “0” in a step S33. However, when P=1, it is set to “0”. If it is not Tall(P−1)>0 as a result of the determination, it is determined that a token is used for the first time in a period P since the system operation, and a flag value F(P)=1 is set, the process is terminated.

On the other hand, it is determined that Tall(P−1)>0. In this case, the latest circulation token activity level derivation processing unit 17 shifts to a step S35 and determines whether or not Tall(P)−Tall(P−1)>0. If it is not Tall(P)−Tall(P−1)>0 as a result of the determination, the latest circulation token activity level derivation processing unit 17 determines whether P>=L>1 or not in a step S36. Then when it is not P>=L>1, the latest circulation token activity level derivation processing unit 17 determines whether L>P>=1 or not in a step S37, and when a result of this determination is not L>P>=1, judges that the token has been used while a short period of time less than 1 has passed, but it has not been used in the latest period, and sets the flag value F(P)=2, and the process is terminated. On the other hand, when L>P>=1, the latest circulation token activity level derivation processing unit 17 determines that the token is used during only a short time of 1 or more and less than L since the system operation but is not used in the latest, and in a step S39, sets a flag value F(P)=3, and terminate the process.

When P>=L>1 is determined in the step S36, the latest circulation token activity level derivation processing unit 17 then determines whether or not Tall(P)−Tall(P−L)>0 is satisfied in a step s40. When the result of the determination is not Tall(P)−Tall(P−L)>0, the latest circulation token activity level derivation processing unit 17 judges that it is in a state where no token has been used during the last relatively long period of L, although L or more time has passed since the system started operating, that is, a state where the system activity level is lost, sets a flag value F(P)=4 in a step S41, and terminate the process.

On the other hand, when Tall(P)−Tall(P−L)>0, the latest circulation token activity level derivation processing unit 17 judges that it is in a state where L or more time has passed since system operation and that the token has been used during the most recent relatively long time L, that is, a state where the token usage activity level has been maintained, sets the flag value F(P)=7 in a step S42 and terminate the process. At the same time, the latest circulation token activity level derivation processing unit 17 calculates the circulation activity level M(P) of the token in the step S42. The circulation activity level M(P) of the token is calculated as follows.

$$T 1 ( P ) = \{ Tall ( P ) - Tall ( P - 1 ) \} / 1.$$

$$TL ( P ) = \{ Tall ( P ) - Tall ( P - 1 ) \} / L .$$

$$M ( P ) = T 1 ( P ) / TL ( P )$$

On the other hand, it is determined that Tall(P)−Tall(P−1)>0 as a result of the determination in the step S35. In this case, the latest circulation token activity level derivation processing unit 17 determines whether P>=L>1 or not in a step S43. If it is not P>=L>1, the latest circulation token activity level derivation processing unit 17 determines whether L>P>=1 or not in a step S44. If L>P>=l as a result of the determination, the latest circulation token activity level derivation processing unit 17 judges that the token is used during only a short time of less than 1 since the system operation and the token is used at least in the immediate vicinity, and sets a flag value F(P)=5 in a step S45. On the other hand, when L>P>=1, the latest circulation token activity level derivation processing unit 17 judges that the token is used during only a short time of 1 or more and less than L since the system operation, and that the token is used at least in the immediate vicinity, sets a flag value F(P)=6 in a step S46, and terminate the process.

When P>=L>1 is determined in the step S43, the latest circulation token activity level derivation processing unit 17 judges that it is in a state where the token is used for a latest relatively long time L after the lapse of a time of L or more since the system operation, that is, a state where the token usage activity level is kept, goes to a step S47 and sets a flag value F(P)=7. At the same time, the latest circulation token activity level derivation processing unit 17 calculates the circulation activity level M(P) of the token in the step S47. The circulation activity level M(P) of the token is calculated as follows.

$$T 1 ( P ) = \{ Tall ( P ) - Tall ( P - 1 ) \} / 1.$$

$$TL ( P ) = \{ Tall ( P ) - Tall ( P - 1 ) \} / L .$$

$$M ( P ) = T 1 ( P ) / TL ( P )$$

### (2-3) Generation of Content Per Token Circulation Quantity

Next, the control unit 1 of the server device SV reads the total circulation quantity Tall(t) of tokens at the time t from the total circulation quantity acquisition processing unit 16 at first under the control of the content per token circulation quantity generation processing unit 19, and reads the circulation activity level M(t) of the latest token at the time t from the latest circulation token activity level derivation processing unit 17 in a step S22. Then, the content per token circulation quantity generation processing unit 19 generates a total circulation quantity Tall(t) of the token and a total circulation quantity Tall(t) of the token, based on the parameter stored in the parameter holding DB 36 for content generation and the content parts stored in the content part DB 34, and a content per token circulation quantity that changes according to the circulation activity level M(t) of the latest token, as follows.

That is, the content per token circulation quantity generation processing unit 19 compares a total circulation quantity Tall(t) of the token at the time t with a threshold Th_all which is one of parameters, and obtains a content outline determination value Sall(t) at the time t. For example, when Th_all=500, the content outline determination values are Sall(t)=0 (if 0=<Tall<500) and Sall(t)=1 (if 500=<Tall).

The threshold Th_all is a positive value, and is edited by the content generation parameter editing processing unit 23 in accordance with the operation of the system manager. A plurality of threshold Th_all may be set, and in that case, the value of Sall(t) is also provided as many as the corresponding number.

The content per token circulation quantity generation processing unit 19 obtains a content detail determination value Sm(t) at time t on the basis of the flag value F(P) obtained by the latest circulation token activity level derivation processing unit 17 and the circulation activity level M(t) of the latest token at time t, as follows.

That is, when the flag value is F(P)=1, that is, when the token has not been used yet since the system operation, Sm(t)=0 is set. When the flag value is F(P)=1, that is, when the token is used for the first time in the period P since the system operation, Sm(t)=1 is set. Further, when the flag value is F(P)=2, that is, when the token is used during only a short time of less than 1 since the system operation, Sm(t)=2.

On the other hand, when the flag value is F(P)=3, that is, when the token has been used during only a short time of 1 or more and less than L since the system operation but has not been used in the latest period, Sm(t)=3. In addition, when the flag value is F(P)=4, that is, since the system operation, although a time equal to or longer than L has elapsed, the token is not used during the latest relatively long time L, in a state where the system activity is lost, Sm(t)=4.

Similarly, when the flag value is F(P)=5, that is, when since the system operation, the token is used while only a short time of less than 1 elapses, and further when the token is used at least in the immediate vicinity, Sm(t)=5. When the flag value is F(P)=6, that is, in a state where the token is used during only a short time of 1 or more and less than L since the system operation, and the token is used at least in the immediate vicinity, Sm(t)=6.

Finally, when the flag value is F(P)=7, that is, in a state where since the system operation, a time equal to or longer than L elapses and the token is used during the latest relatively long time L, in a state where the token usage activity level is maintained, M(t) is obtained by comparing M(t) with two preset thresholds Th_m1, Th_m2 (Th_m1<Th_m2). For example, if M(t)=<Th_m1, then Sm(t)=6 is set. Also, if Th_m1<M(t)=<Th_m2, then Sm(t)=7 is set. Further, if Th_m2<M(t), then Sm(t)=9 is set.

The threshold Th_m1 and Th_m2 are not limited to two but can be set arbitrarily. That is, n thresholds Th_m(n) (n is a natural number of 1 or more, and Th_m(k)<Th_m(k+1), when n>2, k is a natural number of 1 or more and n−1 or less). Then, Sm(t) is obtained by comparing M(t) with the n threshold values.

For example, if M(t)=<Th_m(1) at n=2, then Sm(t)=7 is obtained as described above. Similarly, if Th_m(1)<: M(t)=<Th_m(2), Sm(t)=8, further if Th_m(2)<M(t), Sm(t)=9 is obtained.

Then, the content per token circulation quantity generation processing unit 19 reads out from the content part DB 34, a first content C1 and a second content C2 corresponding to a combination of a content outline determination value Sall(t) based on the total token circulation quantity and a content detail determination value Sm(t) based on an elapsed time from the start of use of the system and the latest token circulation quantity, as obtained above.

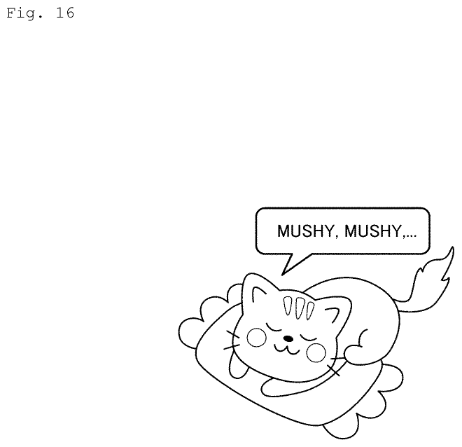

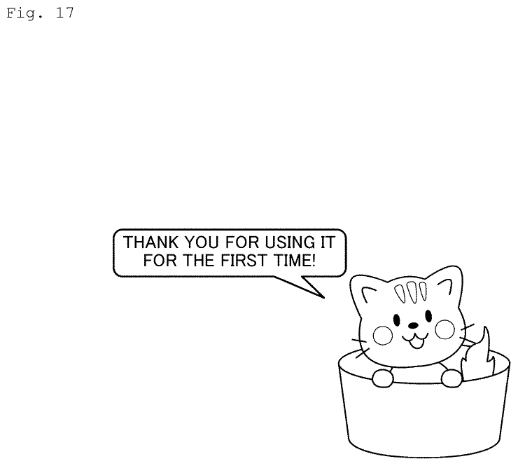

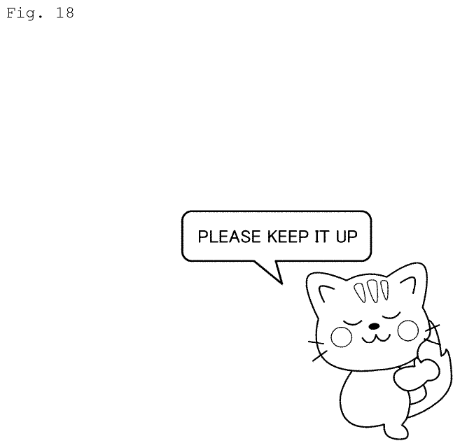

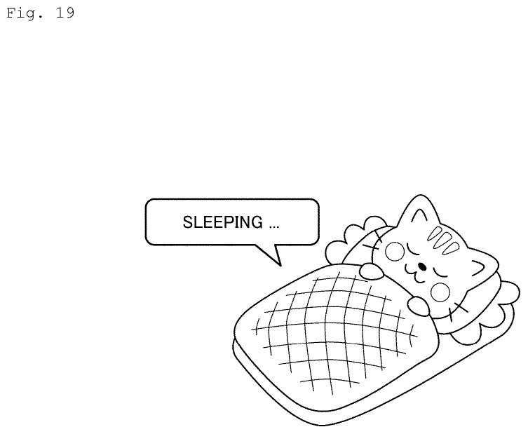

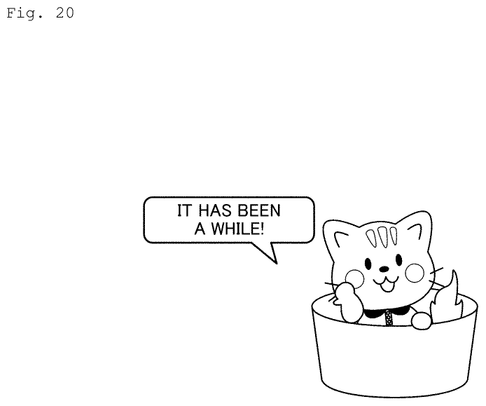

For example, when parts information shown in FIG. 10 is stored in the content part DB 34 and illustration data shown in FIG. 11 is associated with the first content C1, the content per token circulation quantity generation processing unit 19 for each token circulation quantity generates a content per token circulation quantity as shown in FIG. 12 by combining the content C1 composed of illustration data, and the content C2 composed of text data, for example. FIGS. 16 to 20 show other examples of contents per token circulation quantity.

### (2-4) Derivation of the Utilization Characteristic Area Related Information

The control unit 1 of a server device SV, under control of the use specific region related information derivation processing unit 18, in a step S23, derives specific region related information including a specific region in which an event has been executed most recently, an execution state of the event in the specific region and a circulation state of the token, as follows.

That is, the use specific region related information derivation processing unit 18 divides the service target area into a plurality of areas in a mesh shape in a predetermined unit. Then, the number of the area where the event is executed is derived from the plurality of areas on the basis of the execution position coordinates of the event included in the information stored in the token transfer history DB 33. Since the event in which the execution position coordinates are not defined is an on-line event, the area number is assumed to be “00”.

The use specific region related information derivation processing unit 18 reads a specific region name from the specific region information DB 35 on the basis of the derived area number. For example, information shown in FIG. 13 is stored in the specific region information DB 35, and “on-line” is read when the derived area number is A00, and “Rokkaku Park” is read when the area number is A20.

The use specific region related information derivation processing unit 18 calculates, for each area, the number of times of execution for each event executed in the area and the total number of times of execution of the event in the area. Further, the use specific region related information derivation processing unit 18 calculates a circulation quantity of tokens for each event executed in the area for each area.

Then, the use specific region related information derivation processing unit 18 stores the above read specific region name, the calculated execution frequency by event for each area, the total execution frequency of events for each area, and a token circulation quantity for each event as specific region related information.

### (2-5) Generation of the Content for Each Area

The control unit 1 of a server device SV next, under control of the content per region generation processing unit 20, in a step S24, specifies an area in which the use of tokens is increasing, on the basis of the parameter stored in the content generation parameter holding DB 36 and the specific region related information for each area derived by the use specific region related information derivation processing unit 18. Then, the control unit 1 generates a content for each area representing an event being executed in the specified area.

For example, the content per region generation processing unit 20 first sorts specific regions (areas where events are executed) in the descending order of the total execution frequency of the events included in the specific region related information. Next, specific regions where the total execution frequency of the events exceeds a threshold value Teve stored in the content generation parameter holding DB 36, and up to the N-th upper order are selected as areas in full swing. The above N is also stored in the content generation parameter holding DB 36. At the same time, all the events up to the m-th higher order of which the number of times of execution is large are selected as events in full swing.

For example, the content per region generation processing unit 20 sorts the specific regions in the descending order of the total circulation quantity of tokens included in the above specific region related information. Then, specific regions where the total circulation quantity of token exceeds a threshold Ttok stored in the content generation parameter holding DB 36, and up to the N-th higher order are selected as areas in full swing. At the same time, all of the events up to the m-th order where the circulation quantity of the token is large are selected as exciting events.

In one example, as exciting areas, “Rokkaku Park” and “Tanaka Electric” are selected, and as events in full swing in the “Rokkaku Park”, “fallen leaves cleaning” and “shooting” are selected, and as events in full swing in the “Tanaka Electric”, “appliance pickup service” is selected, respectively.

Then, the content per region generation processing unit 20 generates the content including the name of the area in full swing selected as described above and the name of the event in the exciting area as the content per region. The contents are not generated for areas and events in which tokens are not used.

### (2-6) Synthesis of the Content and its Presentation

The control unit 1 of the server device SV then synthesizes the content generated by the content per token circulation quantity generation processing unit 19 and the content per region generation processing unit 20 in a step S25 under the content synthesis processing unit 21.

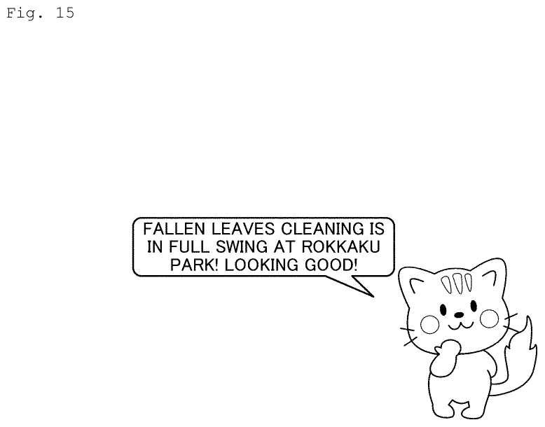

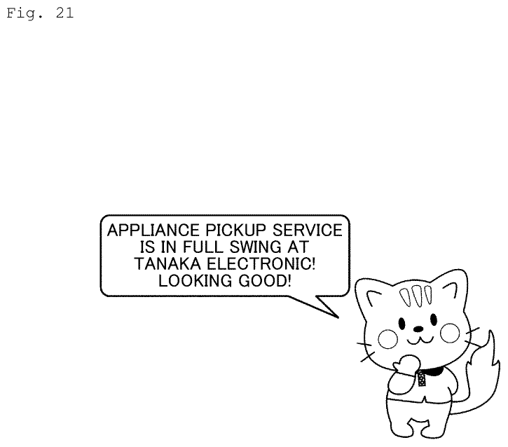

For example, if the content per token circulation quantity is shown in FIG. 12 and the content per area are an area in full swing “Rokkaku Park” and an event in full swing “fallen leaves cleaning”, the content synthesis processing unit 21 synthesizes both the contents, for example, the composite content shown in FIG. 15 is generated. FIG. 21 shows another example of the composite content, and in this example, the area in full swing is “Tanaka Electric” and the event in full swing is “appliance pickup service”.

The control unit 1 of the server device SV finally distributes the composite content generated by the content composition processing unit 21 from a communication I/F unit 4 to the user terminals UT1 to UTn in a step S26 under the control of the content presentation processing unit 22. For example, e-mail or SNS is used as a means of distribution.

In the case of distributing the composite content, the content presentation processing unit 22 acquires the present addresses of the users U1 to Un or the present location information of the user terminals UT1 to UTn in advance, preferentially may select a user living in an area where the exciting event is executed or a user terminal existing in its peripheral area, as a distribution destination.

### Functions and Effects

As described above, in one embodiment, the server device SV performs the following processing.

That is, the control unit 1 of the server device SV performs token transfer processing according to participation of a user in an event, and manages the transfer history information in the token transfer history DB 33. Based on the transfer history information, the token total circulation quantity acquisition processing unit 16 calculates a total circulation quantity Tall(t) of the token at the time t. At the same time, the latest circulation token activity level derivation processing unit 17 calculates an activity level M(t) of token circulation at a time t, and derives a flag value F(t) for determining the propriety of application of a calculation formula of the activity level M(t). The content per token circulation quantity generation processing unit 19 generates the content for each token circulation quantity on the basis of the total token circulation quantity Tall(t) and the token circulation activity level M(t) while taking the flag value F(t) into consideration.

The control unit 1 of the server device SV derives, as specific region related information, a specific region in which an event has been executed most recently and information indicating an execution state of the event and a circulation state of the token in the specific region by the use specific region related information derivation processing unit 18, and generates a content per region including an area name and an event name in which use of the token is increasing by the content per region generation processing unit 20.

Then, the control unit 1 of the server device SV synthesizes generated contents per token circulation quantity and contents per region by the content synthesis processing unit 21, and distributes the synthesized contents to user terminals UT1 to UTn.

Therefore, according to one embodiment, the content per circulation quantity reflecting the total circulation quantity and circulation activity of the latest token, and the content per region reflecting the regional name of region and event name where the use of the token is increasing are synthesized and presented to the user. Thus, the user can confirm the quantitative and regional circulation state of the token by the composite content, and as a result, the user can easily participate in the event, and the event is activated, and the use of the token can be promoted.

In one embodiment, the latest circulation token activity level derivation processing unit 17 sets a flag value F(t) according to the presence or absence of use of a token, the presence or absence of operation of a system, and a relationship between the length of a system operation period and a length of a circulation quantity calculation target period, and the content per token circulation quantity generation processing unit 19 generates a content per token circulation quantity by referring to the set flag value F(t).

Therefore, when the time t is small and the calculation formula of the token circulation activity level M(t) cannot be applied, the calculation formula can be determined by the flag value F(t), and thus, the content per circulation quantity in which the state of the token circulation is appropriately reflected can be generated.

### Other Embodiments

In the above-described one embodiment, the case where the composite content is distributed to the user terminals UT1 to UTN is explained as an example. However, the present invention is not limited to this, and for example, the total circulation quantity and circulation activity level of the latest token used for generating the content, the region name and the event name in which the use of the token is increasing, may be respectively or selectively distributed to the user terminals UT1 to UTn or to the manager terminal MT of the system manager. Thus, the system manager or the user can take measures for promoting the circulation of the tokens.

In the above-described one embodiment, the process related to the execution of the token transfer and the management of the token transfer history, and the process of generating the content based on the token circulation quantity and the token use status by region are executed in one server device SV. However, the former processing and the latter processing may be shared and executed by different information processing devices.

In addition, the configuration, functions, processing procedures, and processing contents of the server device can be implemented with various modifications to the extent that they do not depart from the gist of this invention.

While the embodiment of the present invention has been described in detail, the above description is only an example of the present invention in all respects. Naturally, various improvements and modifications can be made without departing from the spirit of the present invention. That is, when the present invention is embodied, a specific configuration corresponding to an embodiment may be employed appropriately.

This invention is not limited to the embodiment as it is but can be embodied by modifying components in the practical phase without departing from the gist thereof. Also, various inventions can be formed by suitably combining a plurality of components disclosed in the above-described embodiment. For example, some components of all the components shown in the embodiment may be omitted. Furthermore, components of different embodiments may be combined as appropriate.

### REFERENCE SIGNS LIST

SV Server device
MT Manager terminal
UT1 to UTn User terminal
NW Network
1 Control unit
2 Program storage unit
3 Data storage unit
4 Communication I/F unit
5 Bus
11 Input reception processing unit
12 Token transfer event execution instruction processing unit
13 Token transfer event edition processing unit
14 User possession token quantity calculation processing unit
15 Token circulation quantity control processing unit
16 Token total circulation quantity acquisition processing unit
17 Latest circulation token activity level derivation processing unit
18 Use specific region related information derivation processing unit
19 Content per token circulation quantity generation processing unit
20 Content per region generation processing unit
21 Content synthesis processing unit
22 Content presentation processing unit
23 content generation parameter edition processing unit
31 Token transfer event information DB
32 User possession token quantity list DB
33 Token transfer history DB
34 Content part DB
35 Specific region information DB
36 Content generation parameter holding DB

1. An information presentation control device used in a system for managing circulation of electronic tokens used as regional currency, comprising:
use history acquisition processing circuitry that acquires use history information indicating a use history of the electronic token for an event to be executed for each area;
first circulation information acquisition processing circuitry that acquires first circulation information indicating a circulation activity level of the electronic token in the entire target region on the basis of the use history information;
second circulation information acquisition processing circuitry that acquires second circulation information indicating a circulation activity level of the electronic token for each of the regions in which the event is executed; and
output processing circuitry that outputs the first circulation information and the second circulation information.

2. The information presentation control device according to claim 1, further comprising:
content information generation processing circuitry that generates content information reflecting a circulation activity level of the electronic token in the entire target region and a circulation activity level of the electronic token in each of the region, based on the first circulation information and the second circulation information.

3. The information presentation device according to claim 2, wherein:
the first circulation information acquisition processing circuitry calculates a circulation activity level of the electronic token at an arbitrary time in a second period, on the basis of a long-term circulation quantity of the electronic token in a predetermined first period and a short-term circulation quantity of the electronic token in a latest second period shorter than the first period, and calculates a total circulation quantity of the electronic token; and
the content information generation processing circuitry obtains a first determination value by comparing the circulation activity level of the electronic token with a first threshold value, obtains a second determination value by comparing the total circulation quantity with a second threshold value, selects a content per circulation quantity corresponding to a combination of the first determination value and the second determination value, and generate the content information including the content per circulation quantity.

4. The information presentation device according to claim 3, wherein:
the first circulation information acquisition processing circuitry sets different flag values according to a use state of each of the electronic tokens in the first period and the second period; and
the content information generation processing circuitry refers to the flag value to determine the circulation activity level of the electronic token.

5. The information presentation device according to claim 2, wherein:
the second circulation information acquisition processing circuitry calculates a circulation quantity of the electronic token for each of the regions in which the event is executed, and calculates a circulation quantity of the electronic token for each of the events which is executed in the region; and
the content information generation processing circuitry selects the region in which the circulation quantity of the electronic token for each region exceeds a third threshold, selects an event in which the circulation quantity of the electronic token for each event exceeds a fourth threshold among the events executed in the selected region, and generate the content information including the content per region representing the selected region and the selected event.

6. The information presentation device according to claim 2, wherein:
the second circulation information acquisition processing circuitry calculates a total execution number of the events executed in each area and an execution number of the events for each of the events, and
the content information generation processing circuitry selects the region in which the total number of times of execution of the events exceeds a fifth threshold, selects an event in which the number of times of execution exceeds a sixth threshold among events executed in the selected region, and generate the content information including the content per region representing the selected region and the selected event.

7. An information presentation control method, comprising:
acquiring use history information indicating a use history of the electronic token for an event to be performed in each region;
acquiring first circulation information indicating circulation activity level of the electronic token in the entire target area based on the use history information;
acquiring second circulation information indicating circulation activity level of the electronic token for each of the regions in which the event is performed, on the basis of the use history information; and
outputting the first circulation information and the second circulation information.

8. A non-transitory computer readable medium storing a program that causes a processor equipped with the information presentation control device of claim 1 to perform the processing by each of the circuitries of the information presentation control device.

9. A non-transitory computer readable medium storing a program that causes a processor to perform the method of claim 7.
